(19) United States
(12) Patent Application Publication
(10) Pub. No.: US 2011/0162032 A1
(43) Pub. Date: Jun. 30, 2011

(54) TELEVISION SYSTEM, TELEVISION, AND SET TOP BOX

(75) Inventor: LUNG DAI, Tu-Cheng (TW)

(73) Assignee: HON HAI PRECISION INDUSTRY CO., LTD., Tu-Cheng (TW)

(21) Appl. No.: 12/890,818

(22) Filed: Sep. 27, 2010

(30) Foreign Application Priority Data
Dec. 24, 2009 (TW) 98144656

(51) Int. Cl. H04N 7/16

(52) U.S. Cl. 725/151

(57) ABSTRACT

A set top box (STB) includes a signal receiver and at least one optical fiber cable. The signal receiver receives optical signals from a remote controller. The at least one optical fiber cable is electrically connected to the signal receiver. The at least one optical fiber cable includes an input terminal and an output terminal, the input terminal receives the optical signals and the output terminal outputs the optical signals to the signal receiver.

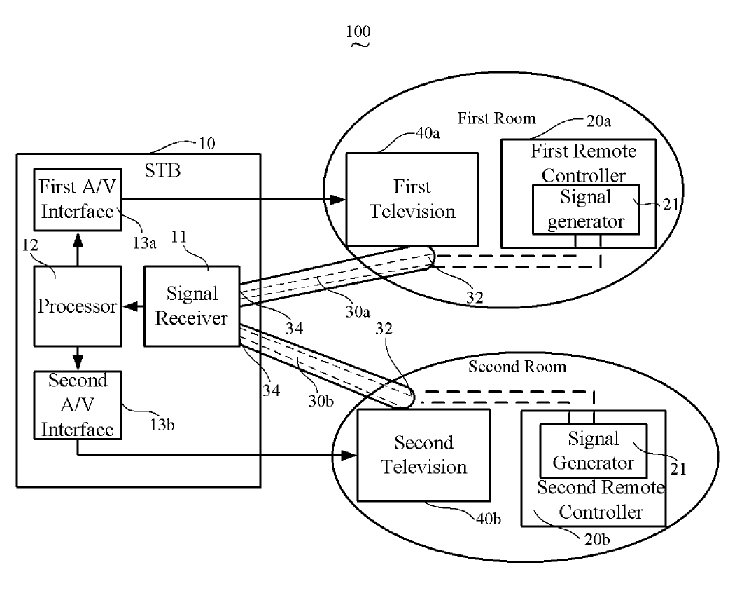

### BACKGROUND

1. Technical Field

The present disclosure relates to a digital television system, and particularly to a television and a set top box of the television system.

2. Description of Related Art

Digital television systems provide more channels and high quality television programs. Digital television systems often include a set top box (STB) and a television. The STB connects the television and an external source for generating television signals, and transforms the television signals into content which is then displayed on the television screen.

Although, a conventional STB in a first room is capable of respectively connecting to two televisions in two different rooms. The conventional STB cannot be controlled by a remote control operated in a second room so the user must go to the first room to change the programs on the television in the second room. This can be very inconvenient for the user to keep going from one room to the other in order to change the television program.

Therefore, there is room for improvement within the art.

### BRIEF DESCRIPTION OF THE DRAWINGS

Many aspects of the embodiments can be better understood with reference to the following drawing. The components in the drawing are not necessarily drawn to scale, the emphasis instead being placed upon clearly illustrating the principles of the present embodiments.

The FIGURE is a schematic diagram of a digital television system in accordance with an exemplary embodiment.

### DETAILED DESCRIPTION

The present disclosure provides a television system which utilizes optical fiber cables to transmit control signals generated by remote control to a set top box (STB) connected to a number of televisions, allowing the STB to be controlled by remote controls in different rooms.

Referring to the FIGURE, a television system 100 is illustrated. The television system 100 includes a STB 10, a number of remote controls for controlling the STB 10, a number of optical fiber cables, and a number of televisions. The STB 10 provides a television signal to the televisions. The televisions reproduce the television program corresponding to the television signal. In this embodiment, the television system 100 includes a first and a second televisions 40a and 40b, a first and a second remote controls 20a and 20b, and a first and a second optical fiber cables 30a and 30b.

The first and the second remote controls 20a and 20b generate user command signals in response to user operations, the user command signals are optical signals, such as infrared signals. Each of the first and the second remote controls 20a and 20b include a number of buttons (not shown) and a signal generator 21. The signal generator 21 is an infrared generator, the signal generator 21 generates the user command signals when the user operates the buttons.

The first and the second optical fiber cables 30a and 30b respectively receive the user command signals from the first and the second remote controls 20a and 20b. Both the first and the second optical fiber cables 30a and 30b include an input terminal 32 and an output terminal 34 at the two opposite ends thereof. In this embodiment, the input terminals 32 of the first and the second optical fiber cables 30a and 30b may be respectively combined with the first and the second televisions 40a and 40b The output terminals 34 of the first and the second optical fiber cables 30a and 30b are both coupled to the STB 10. The length of the first and the second optical fiber cables 30a and 30b can be determined according to requirements needed by the first and the second optical fiber cables 30a and 30b to be coupled to the STB 10. When the user located near the first television 40a or the second television 40b, while operating either the first remote control 20a or the second remote control 20b, the input terminals 32 can receive the user command signals generated by the first remote control 20a or the second remote control 20b and the user command signals are transmitted to the STB 10 by the output terminals 34 coupled to the STB 10.

The STB 10 receives the user command signals from the first and the second optical fiber cables 30a and 30b, and provides television signals to the first and the second television 40a and 40b in response to the users commands. The STB 10 includes a signal receiver 11, a processor 12, and a first audio/video (A/V) interface 13a, and a second A/V interface 13b. The first and the second A/V interfaces 13a and 13b may be a Composite Video Broadcast Signal (CVBS) or a High Definition Multimedia Interface (HDMI). The first and the second A/V interfaces 13a and 13b are respectively electrically connected to A/V interfaces (not shown) of the first and the second televisions 40a and 40b by A/V signal wires As a result, the STB 10 electrically connects to the first and the second televisions 40a and 40b.

The signal receiver 11 receives the optical signals, such as infrared signal. The signal receiver 11 is electrically connected to the output terminals 34 of the first and the second optical fiber cables 30a and 30b to receive the user command signals transmitted from the first and the second optical fiber cables 30a and 30b.

The processor 12 generates the television signals in response to the user command signals, and transmits the television signals to the first and second televisions 40a and 40b to be reproduced by the first and the second A/V interface 13a and 13b.

How the television system 100 is operated by the STB 10, when the first and the second televisions 40a and 40b are located in different rooms, will be described below.

When the first television 40a and the first remote control 20a are located in the first room, the second television 40b and the second remote control 20b are located in the second room. The STB 10 is located in a third room, a first user is in the first room viewing television, and a second user is in the second room viewing television. If the first user operates the first remote control 20a to select a program, the first remote control 20a generates a user command signal. The input terminal of the first optical fiber cable 30a combined with the first television 40a will receive the user command signal, the STB 10 will receive the user command signal by the output terminal 34 of the first optical fiber cable 30a coupled to STB 10. As a result, the STB 10 can provide corresponding television signal in response to the user command signal. Likewise, if the second user operates the second remote control 20b, the STB 10 can also be manipulated to provide corresponding television signal.

As described above, the STB 10 of the television system in the third room 100 can be controlled by the remote controls 20a and 20b, which are respectively operated by users in the different rooms.

It is to be understood, however, that even though information and advantages of the present embodiments have been set forth in the foregoing description, together with details of functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A set top box (STB) comprising:
a signal receiver capable of receiving optical signals from a remote controller;
at least one optical fiber cable electrically connected to the signal receiver, wherein the at least one optical fiber cable comprises an input terminal and an output terminal, the input terminal is configured to receive the optical signals and the output terminal is configured to output the optical signals to the signal receiver.

2. The STB of claim 1, wherein the input terminal is combined with a television which is connected to the STB.

3. The STB of claim 1, wherein the signal receiver is capable of receiving infrared signals.

4. The STB of claim 1, wherein the input terminal and the output terminal are at two opposite ends of the at least one optical fiber cable.

5. A television for receiving and reproducing televisions signals from a STB, the STB capable of receiving optical signals from a remote controller and generating the televisions signals in response to the optical signals, wherein the television comprises at least one optical fiber cable, the at least one optical fiber cable comprises an input terminal and an output terminal, the input terminal is combined with the television to receive the optical signals and the output terminal is configured to output the optical signals to the STB.

6. The television of claim 5, wherein the optical signals are infrared signals.

7. The television of claim 5, wherein the input terminal and the output terminal are at two opposite ends of the optical fiber cable.

8. A television system comprising:
a set top box (STB) to provide television signals in response to optical signals from a remote controller;
at least one television connected to the STB to receive and reproduce the television signals; and
at least one optical fiber cable with an input terminal and an output terminal, the input terminal receiving the optical signals from the remote controller, the output terminal output the optical signals to the STB.

9. The television system of claim 8, wherein the input terminal is combined with the television.

10. The television system of claim 8, wherein the STB comprise a signal receiver to receive the optical signals, the output terminal is electrically connected to the signal receiver.

11. The television system of claim 8, wherein the optical signals are infrared signals.

12. The television system of claim 8, wherein the input terminal and the output terminal are at two opposite ends of the optical fiber cable.
